(19) United States
(12) Patent Application Publication
(10) Pub. No.: US 2019/0255912 A1
(43) Pub. Date: Aug. 22, 2019

(54) CABIN HEATING SYSTEM WITH SEALED HEAT TRANSFER LOOP

(71) Applicant: FORD GLOBAL TECHNOLOGIES, LLC, Dearborn, MI (US)

(72) Inventors: Joseph Norman Ulrey, St. Joseph, MI (US); Gopichandra Surnilla, West Bloomfield, MI (US); Ross Dykstra Pursifull, Dearborn, MI (US); Thomas George Leone, Ypsilanti, MI (US)

(21) Appl. No.: 15/899,090

(22) Filed: Feb. 19, 2018

(51) Int. Cl. B60H 1/20; F01N 5/02

(52) U.S. Cl. CPC B60H 1/20; F01N 5/02

(57) ABSTRACT

A cabin heating system includes a cabin air heat exchanger, an exhaust gas heat exchanger and a heat transfer loop. The heat transfer loop circulates a gaseous heat exchange fluid between the cabin air heat exchanger and the exhaust gas heat exchanger.

### TECHNICAL FIELD

This document relates generally to the motor vehicle equipment field and, more particularly, to a new and improved cabin heating system that incorporates a sealed heat transfer loop as well as to a new and improved method of heating a passenger cabin of a motor vehicle.

### BACKGROUND

Unfortunately, engine coolant based cabin heating fails to provide instant cabin heat when the motor vehicle has been sitting for substantial periods of time in cold weather conditions. This document relates to a new and improved cabin heating system and method that provides near instantaneous cabin heating by recovering heat from the exhaust gases of the internal combustion engine of the motor vehicle. Advantageously, this is done in a safe and very efficient manner. As such, the present cabin heating system and method represent a significant advance in the art.

### SUMMARY

In accordance with the purposes and benefits described herein, a new and improved cabin heating system is provided. That cabin heating system comprises a cabin air heat exchanger, an exhaust gas heat exchanger and a heat transfer loop that circulates a gaseous heat exchange fluid between the cabin air heat exchanger and the exhaust gas heat exchanger.

The heat transfer loop may include a conduit, having a first heat exchange section and a second heat exchange section, and a pump. The pump circulates the gaseous heat exchange fluid through the conduit. In addition, the heat exchange loop includes a pressure monitoring device. The pressure monitoring device monitors the pressure of the gaseous heat exchange fluid in the heat transfer loop.

The heat transfer loop may also include a check valve to ingest air into the heat transfer loop. In addition, the cabin heating system may further include an exhaust gas bypass having a first end and a second end connected to an exhaust gas conduit.

The first heat exchange section may be positioned in the exhaust gas bypass between the first end and the second end. A throttle valve may be positioned in the exhaust gas conduit between the first end and the second end of the exhaust gas bypass. In addition, the exhaust gas bypass may be downstream from a catalytic converter of the motor vehicle. Further, the cabin air heat exchanger may include a fan to move cabin air across the second heat exchange section of the heat transfer loop at the cabin air heat exchanger.

In accordance with an additional aspect, a method of heating a passenger cabin of a motor vehicle is provided. That method may comprise the steps of: a) circulating a gaseous heat exchange fluid through a heat transfer loop between an exhaust gas heat exchanger and a cabin air heat exchanger, b) heating the gaseous heat exchange fluid by transferring heat from exhaust gas to the gaseous heat exchange fluid in the exhaust gas heat exchanger and c) heating cabin air by transferring heat from the gaseous heat exchange fluid to the cabin air in the cabin air heat exchanger.

The method may further include the step of using ambient air as the gaseous heat exchange fluid. Further, the method may include the step of positioning a first heat exchange section of the heat transfer loop in an exhaust gas bypass downstream from a catalytic converter of the motor vehicle.

Still further the method may include the step of controlling flow of the exhaust gas through the exhaust gas bypass by using a throttle valve. In addition, the method may include circulating the gaseous heat exchange fluid through the heat transfer loop by using a pump.

The method may also include the step of monitoring pressure of the gaseous heat exchange fluid in the heat transfer loop by using a pressure monitoring device. Further, the method may include the step of ingesting air into the heat transfer loop past a check valve. In addition, the method may include the step of moving cabin air across a second heat exchange section of the heat transfer loop at the cabin air heat exchanger by using a fan.

In the following description, there are shown and described several preferred embodiments of the cabin heating system and the related method of heating a passenger cabin of a motor vehicle. As it should be realized, the cabin heating system and method are capable of other, different embodiments and their several details are capable of modification in various, obvious aspects all without departing from the cabin heating system and method as set forth and described in the following claims. Accordingly, the drawings and descriptions should be regarded as illustrative in nature and not as restrictive.

### BRIEF DESCRIPTION OF THE DRAWING FIGURES

The accompanying drawing FIGURES incorporated herein and forming a part of the specification, illustrate several aspects of the cabin heating system and method of heating a passenger cabin of a motor vehicle and together with the description serve to explain certain principles thereof.

FIG. 1 is a schematic illustrating the cabin heating system.

Reference will now be made in detail to the present preferred embodiments of the cabin heating system and related method, examples of which are illustrated in the accompanying drawing FIGURES.

### DETAILED DESCRIPTION

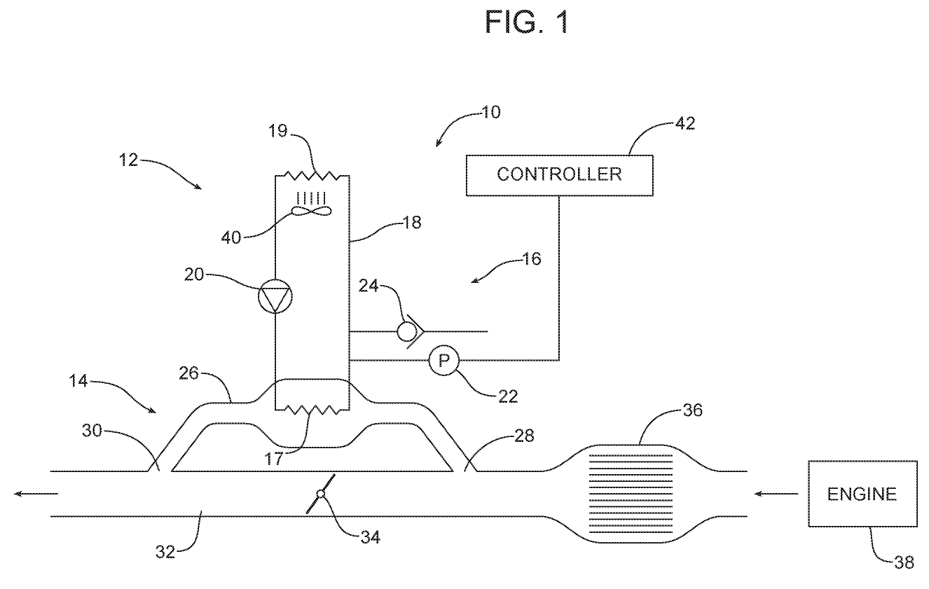

Reference is now made to FIG. 1 illustrating the new and improved cabin heating system 10 for safely and efficiently heating a passenger cabin of a motor vehicle. The cabin heating system 10 includes a cabin air heat exchanger 12, an exhaust gas heat exchanger 14 and a heat transfer loop 16. The heat transfer loop 16 functions to circulate a gaseous heat exchange fluid, such as ambient air, between the cabin air heat exchanger 12 and the exhaust gas heat exchanger 14. More specifically, the heat transfer loop 16 includes a conduit 18 and a pump 20. The pump functions to circulate the gaseous heat exchange fluid through the conduit 18. The heat transfer loop 16 also includes a first heat exchange section 17 and a second heat exchange section 19 in the conduit 18.

In addition, the heat transfer loop 16 includes a pressure monitoring device 22 that functions to monitor the pressure of the gaseous heat exchange fluid in the heat transfer loop 16. Further, the heat transfer loop 16 includes a check valve 24 that functions to ingest air into the heat transfer loop when the pressure of the gaseous heat exchange fluid falls below a predetermined level for any reason. That air may be draw in from the engine's air duct post compressor so that the air in the conduit 18 is more dense.

The exhaust gas heat exchanger 14 of the cabin heating system 10 also includes an exhaust gas bypass 26 having a first end 28 and a second end 30 connected to an exhaust gas conduit 32.

The first heat exchange section 17 is positioned in the exhaust gas bypass 26 between the first end 28 and the second end 30. A throttle valve 34 is positioned in the exhaust gas conduit 32 between the first end 28 and the second end 30 of the exhaust gas bypass 26. That exhaust gas bypass 26 is located downstream from the catalytic converter 36 that receives exhaust gases from the internal combustion engine 38 of the motor vehicle. Still further, the cabin heating system 10 includes a fan 40 to move cabin air through the cabin air heat exchanger 12 and across the second heat exchange section 19 whereby heat is transferred from the gaseous heat exchange fluid in the heat transfer loop 16 to the cabin air being moved by the fan 40 and circulated through the passenger cabin for the comfort of the passengers within the motor vehicle.

The cabin heating system 10 is useful in a method of heating the passenger cabin of a motor vehicle. That method includes the steps of: a) circulating the gaseous heat exchange fluid through the heat transfer loop 16 between the exhaust gas heat exchanger 14 and the cabin air heat exchanger 12, b) heating the gaseous heat exchange fluid passing through the first heat exchange section 17 by transferring heat from the exhaust gas generated by the internal combustion engine 38 to the gaseous heat exchange fluid in the exhaust gas heat exchanger and c) heating cabin air passing through the second heat exchange section 19 by transferring heat from the gaseous heat exchange fluid to the cabin air in the cabin air heat exchanger 12.

Toward this end the method includes using ambient air as the gaseous heat exchange fluid. Further, the method includes the step of positioning the first heat exchange section 17 in an exhaust gas bypass 26 downstream from the catalytic converter 36 of the motor vehicle.

Still further, the method includes controlling the flow of the exhaust gas through the exhaust gas bypass 26 by using a throttle valve 34 positioned in the exhaust gas conduit 32 between the first end 28 and second end 30 of the exhaust gas bypass.

Still further, the method includes the method of circulating the gaseous heat exchange fluid through the heat transfer loop 16 by utilizing the pump 20. Further, the method includes monitoring the pressure of the gaseous heat exchange fluid in the heat transfer loop 16 by using the pressure monitoring device 22. In addition, the method includes ingesting air into the heat transfer loop 16 past the check valve 24 whenever the pressure of the air in the heat transfer fluid falls below ambient air pressure. In the event the pressure of the ambient air in the heat transfer loop 16 suddenly changes for any reason, such as due to the development of a leak in the cabin air heat exchanger 12 or the exhaust gas heat exchanger 14, the cabin heating system 10 may be immediately shut down. If a single leak occurs at 17, exhaust gasses cannot enter the cabin. If a single leak occurs at 19, exhaust gasses cannot enter the cabin. The pressure sensor detects lack of pressure build with hot exhaust in the loop before a second leak is likely to form. Toward this end, pressure data may be continuously provided from the pressure monitoring device 22 to a controller 42 in the form of a computing device such as a dedicated microprocessor or electronic control unit operating in accordance with instructions from appropriate control software.

The method may also include the step of ingesting air into the heat transfer loop 16 past the check valve 24 in order to maintain a desired pressure of heat exchange fluid in the heat transfer loop. Further, the method may include moving cabin air through the cabin air heat exchanger 12 past and over the second heat exchange section 19 by using the fan 40.

Certainly, the authors see the heat transfer advantage in using liquid coolant in loop 18, however, we wanted to capture the advantage of avoiding the design actions one must take to deal with coolant boiling and expanding. Further, we wanted the weight advantage of using a gas. Also note that the gas is self-pressurizing which increases it thermal capacity on a volume basis. A two phase fluid may be used (e.g. ethanol) but this would require an alternate leak detection (heat exchanger integrity) strategy. Of course, if a fluid other than air is used, check valve path 24 would have to be sealed off.

In summary, the cabin heating system 10 provides a number of benefits and advantages. The cabin heating system 10 includes a dedicated heat transfer loop 16 that circulates a gaseous heat exchange fluid between the cabin air heat exchanger 12 and the exhaust gas heat exchanger 14 thereby isolating the cabin air heat exchanger from the exhaust gases in the exhaust gas heat exchanger. Advantageously, the dedicated heat transfer loop 16 allows for efficient heat exchange between the hot exhaust gases and the gaseous heat exchange fluid passing through the first heat exchange section 17 at the exhaust gas heat exchanger 14 and between the cabin air and the gaseous heat exchange fluid passing through the second heat exchange section 19 at the cabin air heat exchanger 12. Advantageously, the gaseous heat exchange fluid/air in the heat transfer loop 16 allows for rapid heating immediately following startup of the internal combustion engine 38 of the motor vehicle even in bitter cold temperatures. Thus, it is possible to more rapidly provide heating and comfort to passengers in the passenger cabin of the motor vehicle on cold days and nights than is possible in traditional heating systems relying upon heat transfer from engine coolant. Further, this is done in a very efficient, safe and reliable manner.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A cabin heating system, comprising:
a cabin air heat exchanger;
an exhaust gas heat exchanger; and
a heat transfer loop circulating a gaseous heat exchange fluid between said cabin air heat exchanger and said exhaust gas heat exchanger.

2. The cabin heating system of claim 1, wherein said heat transfer loop includes a conduit and a pump, said pump circulating said gaseous heat exchange fluid through said conduit.

3. The cabin heating system of claim 2, wherein said heat transfer loop includes a pressure monitoring device to monitor pressure of said gaseous heat exchange fluid in said heat transfer loop.

4. The cabin heating system of claim 3, wherein said heat transfer loop includes a check valve to ingest air into said heat transfer loop.

5. The cabin heating system of claim 4, wherein said exhaust gas heat exchanger further includes an exhaust gas bypass having a first end and a second end connected to an exhaust gas conduit.

6. The cabin heating system of claim 5, wherein said heat transfer loop includes a first heat exchange section positioned in said exhaust gas bypass between said first end and said second end.

7. The cabin heating system of claim 6, further including a throttle valve positioned in said exhaust gas conduit between said first end and said second end of said exhaust gas bypass.

8. The cabin heating system of claim 7, wherein said exhaust gas bypass is downstream from a catalytic converter.

9. The cabin heating system of claim 8, wherein said cabin air heat exchanger includes a fan to move cabin air across a second heat exchange section of said heat transfer loop at said cabin air heat exchanger.

10. A method of heating a passenger cabin of a motor vehicle, comprising:
circulating a gaseous heat exchange fluid through a heat transfer loop between an exhaust gas heat exchanger and a cabin air heat exchanger;
heating said gaseous heat exchange fluid by transferring heat from exhaust gas to said gaseous heat exchange fluid in said exhaust gas heat exchanger; and
heating cabin air by transferring heat from said gaseous heat exchange fluid to said cabin air in said cabin air heat exchanger.

11. The method of claim 10 including using ambient air as said gaseous heat exchange fluid.

12. The method of claim 11, including positioning a first heat exchange section of said heat transfer loop in an exhaust gas bypass downstream from a catalytic converter of said motor vehicle.

13. The method of claim 12, including controlling flow of said exhaust gas through said exhaust gas bypass by using a throttle valve.

14. The method of claim 13, including circulating said gaseous heat exchange fluid through said heat transfer loop by using a pump.

15. The method of claim 14, including monitoring pressure of said gaseous heat exchange fluid in said heat transfer loop by using a pressure monitoring device.

16. The method of claim 15, including ingesting air into said heat transfer loop past a check valve.

17. The method of claim 16, including moving cabin air across a second heat exchange section of said heat transfer loop at said cabin air heat exchanger by using a fan.
